(19) United States
(12) Patent Application Publication
(10) Pub. No.: US 2011/0078601 A1
(43) Pub. Date: Mar. 31, 2011

(54) DISPLAY DEVICE, DISPLAY METHOD AND MEDIUM

(75) Inventors: Ayako SUGIYAMA, Okazaki-shi (JP); Tomoko SAITO, Nagoya-shi (JP); Syuichiro SHIMOKI, Kitanagoya-shi (JP)

(73) Assignee: Brother Kogyo Kabushiki Kaisha, Nagoya-shi (JP)

(21) Appl. No.: 12/748,044

(22) Filed: Mar. 26, 2010

(30) Foreign Application Priority Data
Sep. 30, 2009 (JP) 2009-226669

(51) Int. Cl. G06F 3/048

(52) U.S. Cl. 715/767

(57) ABSTRACT

A display device includes: a display unit configured to display a list screen visually listing plural setting items including a first setting item in a focused state and a second setting item in a non-focused state; a focus display unit configured to allocate two stages for the first setting item, and to display the first setting item in one of the two stages and a current setting value for the first setting item in the other of the two stages in the list screen; and a non-focus display unit configured to allocate one stage for the second setting item and to display the second setting item in the one stage, without displaying a current setting value for the second setting item, in the list screen.

### CROSS REFERENCE TO RELATED APPLICATION

The present disclosure relates to the subject matter contained in Japanese patent application No. 2009-226669 filed on Sep. 30, 2009, which is expressly incorporated herein by reference in its entirety.

### TECHNICAL FIELD

The present disclosure relates to a display device and a display method that can display a list of setting items on a display unit.

### BACKGROUND ART

As a display device, JP-A-2002-281352 discloses a digital camera that can select a setting item with a cross key, that can display the selected setting item in an enlarged fashion, and that can display the selected setting item and a setting value for the selected setting item side by side. JP-A-2002-261918 discloses a cellular phone that can specify (position a focus on) one of plural icons with up, down, left, and right keys (joy stick), that can display the focal icon with an enlarged size while displaying the other icons with an original size, and that can display a screen for changing a setting value for a setting item corresponding to the focal icon when the focal icon is selected.

However, when the setting item and the setting value are displayed side by side as disclosed in JP-A-2002-281352, a large display area is required in a horizontal direction. This is a problem encountered when a display unit of the display device is small, for example, if a character string showing the setting item and/or the setting value is long, the character string have to be partly omitted for display. When the setting item is represented by the icon as disclosed in JP-A-2002-261918, it is difficult to see what the icon indicate. Further, to refer to the current setting value for the setting item, a user always have to select the icon corresponding to the setting item to retrieve the setting screen. This lowers user's convenience.

### SUMMARY

Under these and other circumstances, a display device disclosed here includes, but not limited to, the following features.

The display device can perform a predetermined function based on setting values set for plural setting items. The display device can display, on a display unit, a list screen that visually lists two or more of the plural setting items. One of the setting items in the list screen can be specified and set into a focused state. The setting item in the focused state can be selected into a selected state in which a setting value for the setting item can be input in response to a predetermined input operation. For example, the display device may be a telephone, a facsimile, a copier, a printer or a multifunction device having two or more of these functions. For example, the predetermined input operation may be an operation of pressing an OK key disposed in the display device.

The display device includes a focus display unit and a non-focus display unit. The focus display unit is configured to allocate two stages for the setting item in a focused state, and to display the setting item in the focused state in one of the two stages in the list screen and the setting value for the setting item in the focused state in the other of the two stages in the list screen. The non-focus display unit is configured to allocate one stage for each setting item in a non-focused state and to display each setting item in the one stage in the list screen.

Accordingly, the setting value only for the setting item in the focused state is displayed in the list screen. Accordingly, the setting item in the focused state can be visually distinguished and the number of setting items simultaneously displayed on the display unit can be guaranteed even when the display unit is small. Further, a user can readily confirm the setting value for the setting item in the focused state when the setting item list screen is displayed, without additional operation steps of selecting the setting item and changing the display screen.

Accordingly, as one of advantages, the display device can improve visibility even with a small display unit.

The advantage and other advantages in connection with the display device disclosed herein will be discussed in detail with reference to the accompanying drawings.

### BRIEF DESCRIPTION OF THE DRAWINGS

FIG. 1A is a perspective view illustrating an outer appearance of a multifunction device and FIG. 1B is a block diagram of the multifunction device.

FIG. 2 is a diagram illustrating an example of setting items and setting values.

FIG. 3 is a flowchart illustrating a list screen displaying process.

FIG. 4 is a flowchart illustrating a focus moving process.

FIG. 5 is a diagram illustrating examples of list screens.

FIG. 6 is a flowchart illustrating a list re-displaying process.

### DESCRIPTION OF THE PREFERRED EMBODIMENT

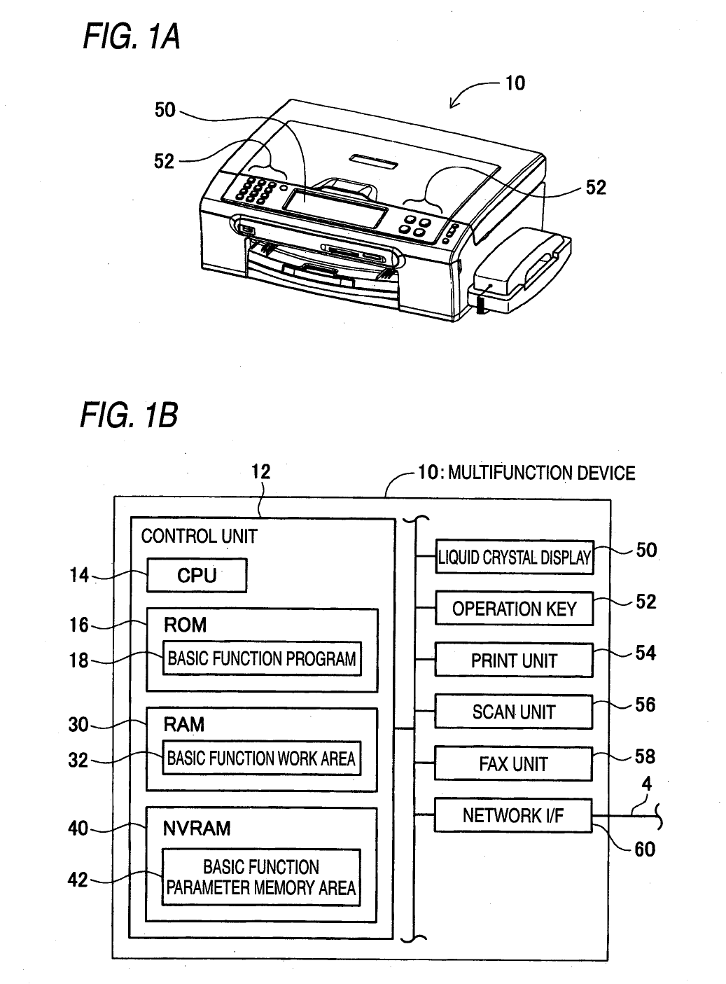

Embodiments will be described with reference to the accompanying drawings. FIGS. 1A and 1B show a multifunction device 10 as an example of a display device. The multifunction device 10 has a copy function, a printer function, a scanner function, a facsimile function, and a phone function. As shown in FIG. 1A, the multifunction device 10 includes a liquid crystal display 50 and an operation key 52 that are disposed on the top front surface of the multifunction device 10. The multifunction device 10 can display various screens on the liquid crystal display 50 depending on the statuses of the multifunction device 10. The operation key 52 includes plural keys such as up, down, left, and right keys, a copy key, an OK key, a back key, a stop key, and a numerical key pad.

As shown in FIG. 1B, the multifunction device 10 includes a control unit 12, the liquid crystal display 50, the operation key 52, a print unit 54, a scan unit 56, a facsimile unit 58, and a network interface 60. The control unit 12 includes a CPU 14, a ROM 16, a RAM 30, and an NVRAM 40.

The CPU 14 performs various processes on the basis of programs stored in the ROM 16. The processes performed by the CPU 14 will be described in detail later. The ROM 16 stores a basic function program 18 for controlling basic operations of the multifunction device 10. The basic function program 18 is used, for example, in a display process of the liquid crystal display 50. The RAM 30 includes a basic function work area 32. The basic function work area 32 is a memory area for storing various data generated in the course of performing the processes in accordance with the basic function program 18. The NVRAM 40 includes a basic function parameter memory area 42. The basic function parameter memory area 42 is a memory area for storing various parameters used for the CPU 14 to perform the processes in accordance with the basic function program 18.

The network interface 60 is connected to a LAN line 4. The multifunction device 10 can communicate with an externally-connected personal computer and can access the Internet.

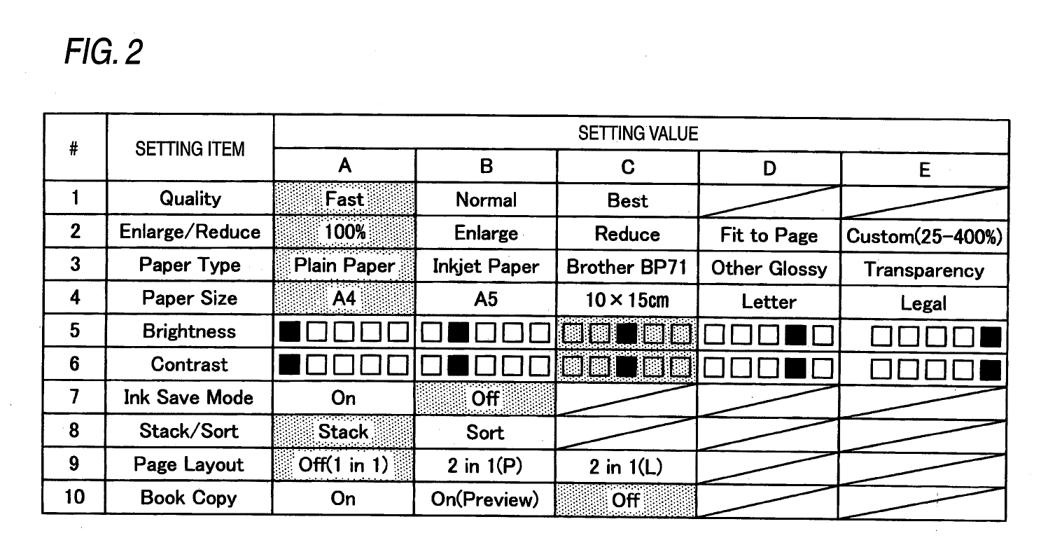

Setting items and setting values stored in the basic function parameter memory area 42 of the NVRAM 40 will be described. FIG. 2 shows specific examples of the setting items and the setting values in the copy function of the multifunction device 10 as examples of the setting items and the setting values. As shown in FIG. 2, in this embodiment, ten setting items to which item numbers 1 to 10 are respectively given and two to five setting values for each setting item exist for the copy function of the multifunction device 10. A user can select the setting value of each setting item from the plural setting values. The setting value which is currently selected for each setting item is displayed in a dot base. The multifunction device 10 performs the copy function on the basis of the setting values set for the setting items. In addition, the setting items and the setting values stored in the basic function parameter memory area 42 of the NVRAM 40 are appropriately transferred to the basic function work area 32 of the RAM 30 so that the CPU 14 can read, from the RAM 30, the setting items and setting values necessary for executing various processes.

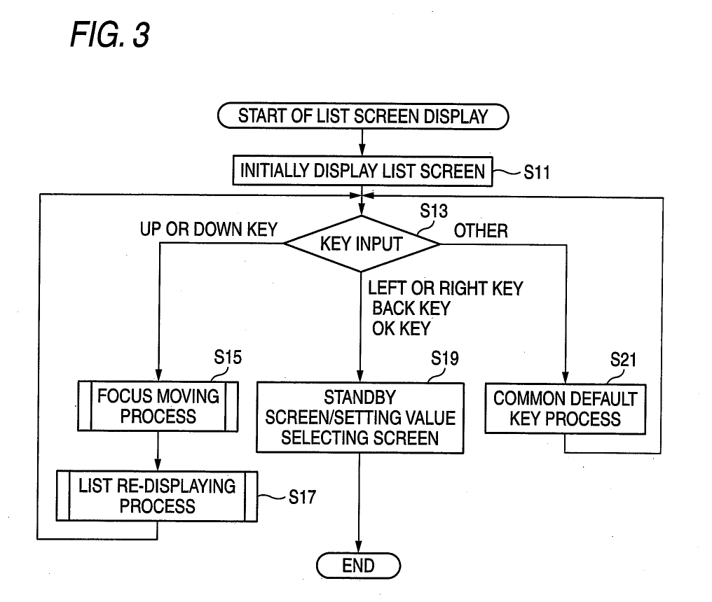

The multifunction device 10 having the above-mentioned configuration can display a list screen having plural setting items arranged therein on the liquid crystal display 50 so that a user can change the setting value of each setting item. For example, when the copy key is pressed in the course of displaying a standby screen, the multifunction device 10 displays the list screen (the standby screen is changed to the list screen). When the OK key is pressed in the course of displaying the list screen, the multifunction device 10 displays a setting value selecting screen (the list screen is changed to the setting value selecting screen) to accept the selection of the setting value. When the back key is pressed in the course of displaying the list screen, the multifunction device 10 displays the standby screen (the list screen returns to the standby screen). When the back key is pressed in the course of displaying the setting value selecting screen, the multifunction device 10 displays the list screen again (the setting value selecting screen returns to the list screen). When the stop key is pressed in the course of displaying the setting value selecting screen, the multifunction device 10 displays the standby screen (the setting value selecting screen is returns to the standby screen). The correspondence of the change of the display screen and the operation key 52 can be designed arbitrarily. For example, the list screen may be changed to the setting value selecting screen with the right key and may be changed to the standby screen with the left key. A list screen displaying process performed by the multifunction device 10 will be described below with reference to FIGS. 3 to 6.

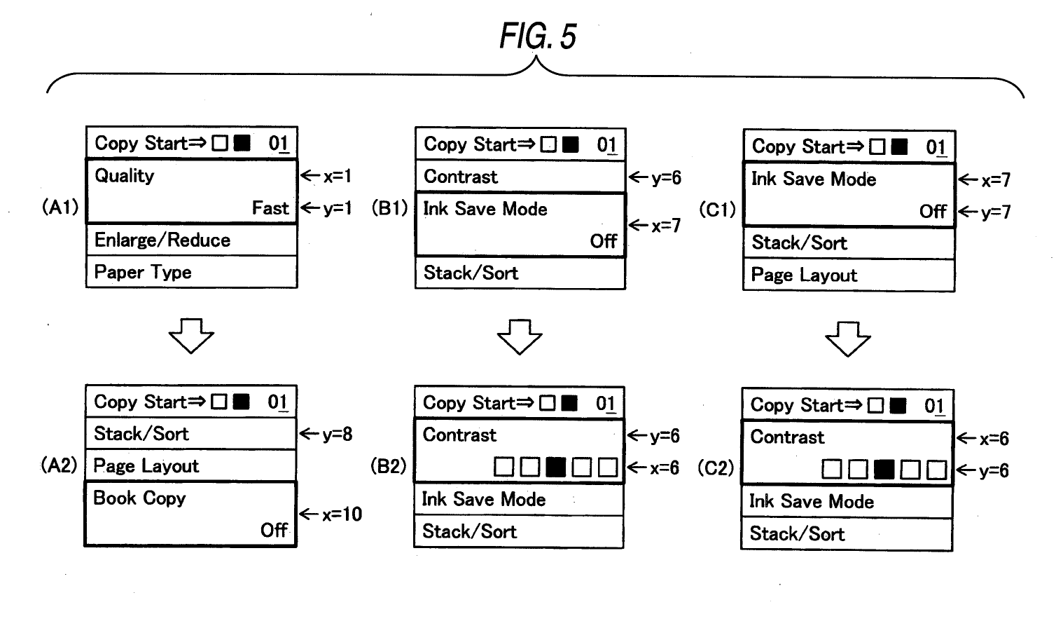

FIG. 3 is a flowchart illustrating the list screen displaying process. The list screen displaying process is started, for example, by pressing the copy key in the course of displaying the standby screen. In S11, the CPU 14 controls the display 50 to initially displays the list screen of setting items on the liquid crystal display 50. In this embodiment, the CPU 14 controls the display 50 to initially displays the list screen A1, shown in FIG. 5, on the liquid crystal display 50. The list screen A1 has three setting items of Quality, Enlarge/Reduce, and Paper Type. In the initial display of this embodiment, the CPU 14 selects the setting item “Quality” as a focused state and displays the setting item “Quality” and the current setting value “Fast” vertically by two stages. In FIG. 5, internal variables x and y used in the list screen displaying process are written aside the display example of the list screen. Here, x is an internal variable indicating the item number of the setting item currently in the focused state. y is an internal variable indicating the item number of the setting item at the uppermost out of three setting items displayed in the list screen. The CPU 14 performs the list screen displaying process using the internal variables x and y stored in the basic function work area 32 of the RAM 30. The initial values of the internal variables x and y are set to x=1 and y=1. As a result, in the initial display of the list screen, the setting item “Quality” of item number 1 is in the focused state and the setting item “Quality” of item number 1, the setting item “Enlarge/Reduce” of item number 2, and the setting item “Paper Type” of item number 3 are sequentially displayed from the upside.

In S13, the CPU 14 performs a key input determining process in response to the user's press of the operation key 52. When the key input is made by the up or down key, the CPU 14 sequentially performs a focus moving process of S15 and a list re-displaying process of S17, and then performs the process of S13 again. The focus moving process of S15 and the list re-displaying process of S17 will be described later. When the key input is made by the left or right key, the back key, or the OK key, the CPU 14 performs the process of S19. In S19, the display screen of the liquid crystal display 50 is changed from the list screen to the standby screen or the setting value selecting screen, and the CPU 14 ends the list screen displaying process. In this embodiment, the display screen of the liquid crystal display 50 is changed to the standby screen when the key input is made by the back key or the left key, and is changed to the setting value selecting screen when the key input is made by the OK key or the right key. As the display screen is changed to the setting value selecting screen in response to the input of the OK key or the right key, the CPU 14 can accept the input of the setting value for the setting item in the focused state. When the key input is made by a key other than the up, down, left, and right keys, the back key, and the OK key, the CPU 14 performs the process of S21. In S21, the CPU 14 performs a common default key process and then performs the process of S13 again. In the common default key process, predetermined processes corresponding to the key input are performed. For example, when the key input is made by the stop key, the CPU 14 stops the list screen displaying process and returns the display screen of the liquid crystal display 50 to the standby screen. When the key input is made by the numerical key pad, the CPU 14 outputs a negative sound indicating that the key input is invalid.

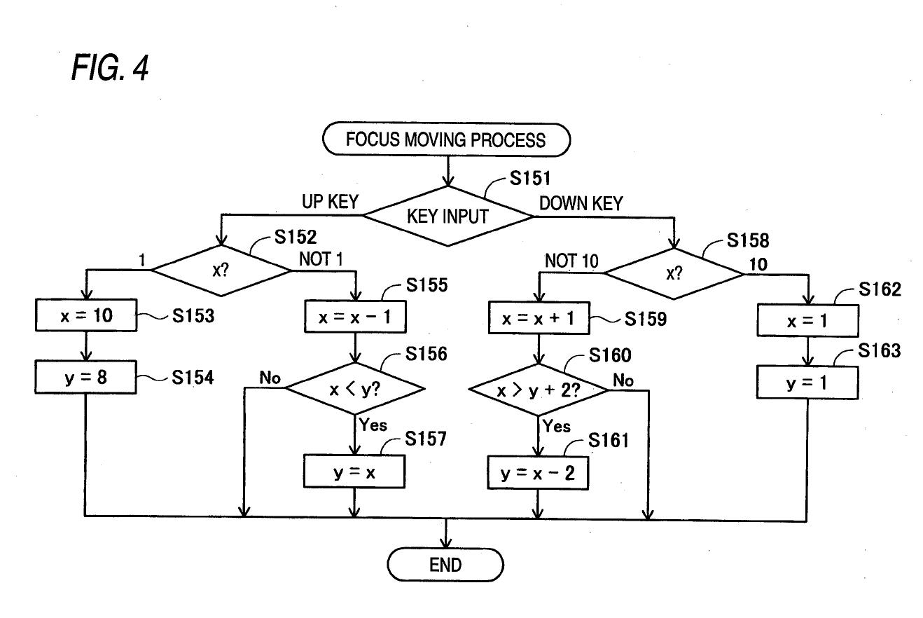

The focus moving process of S15 in FIG. 3 will be described with reference to FIG. 4. In S151, the CPU 14 determines whether the key input is made by the up key or the down key. When the key input is made by the up key, the CPU 14 determines whether the internal variable x is 1 or is not 1 in S152. When it is determined that the internal variable x is 1, the CPU 14 substitutes 10 for the internal variable x in S153, substitutes 8 for the internal variable y in S154, and ends the focus moving process. An example where the focus is moved by the processes of S153 and S154 will be described with reference to the list screens A1 and A2 shown in FIG. 5.

In the list screen A1 shown in FIG. 5, since the internal variable x is 1, the setting item “Quality” of item number 1 is in the focused state. Since the internal variable y is 1, the setting items “Quality”, “Enlarge/Reduce”, and “Paper Type” of item numbers 1 to 3 are sequentially displayed from the uppermost. When the up key is pressed in this state, the internal variables x and y are set to x=10 and y=8 by the processes of S153 and S154. As a result, the list screen A2 shown FIG. 5 is displayed, where the setting item “Book Copy” of item number 10 is in the focused state and the setting items “Stack/Sort”, “Page Layout”, and “Book Copy” of item numbers 8 to 10 are sequentially displayed from the uppermost.

When the internal variable x is not 1 in S152, the CPU 14 subtracts 1 from the internal variable x in S155 and determines whether the internal variables x and y satisfy x<y in s156. When x<y is satisfied (Yes in S156), the CPU 14 substitutes the value of the internal variable x for the internal variable y in S157 and then ends the focus moving process. When x<y is not satisfied (No in S156), the CPU 14 skips the process of S157 and ends the focus moving process. A specific example where the focus is moved by the processes S155, S156, and S157 will be described with reference to list screens B1, B2, C1 and C3 shown in FIG. 5.

In the list screen B1 shown in FIG. 5, since the internal variable x is 7, the setting item “Ink Save Mode” of item number 7 is in the focused state. Since the internal variable y is 6, the setting items “Contrast”, “Ink Save Mode”, and “Stack/Sort” of item numbers of 6 to 8 are sequentially displayed from the uppermost. When the up key is pressed in this state, the internal variable x is changed to x=7−1=6 by the process of S155. Since the internal variable y is 6, the CPU 14 determines that x<y is not satisfied in S156. Accordingly, the CPU 14 skips the process of S157. Therefore, the internal variables x and y are set to x=6 and y=6. As a result, the CPU 14 controls the display 50 to display the list screen B2 shown in FIG. 5, where the setting item “Contrast” of item number 6 is in the focused state and the setting items “Contrast”, “Ink Save Mode”, and “Stack/Sort” of item numbers of 6 to 8 are sequentially displayed from the uppermost.

In the list screen C1 shown in FIG. 5, since the internal variable x is 7, the setting item “Ink Save Mode” of item number 7 is in the focused state. Since the internal variable y is 7, the setting items “Ink Save Mode”, “Stack/Sort”, and “Page Layout” of item numbers of 7 to 9 are sequentially displayed from the uppermost. When the up key is pressed in this state, the internal variable x is changed to x=7−1=6 by the process of S155. Since the internal variable y is 7, the CPU 14 determines that x<y is satisfied in S156. Accordingly, the internal variable y is set to y=x=6 in S157. That is, the internal variables x and y are set to x=6 and y=6. As a result, the CPU 14 controls the display 50 to display the list screen C2 shown in FIG. 5, where the setting item “Contrast” of item number 6 is in the focused state and the setting items “Contrast”, “Ink Save Mode”, and “Stack/Sort” of item numbers of 6 to 8 are sequentially displayed from the uppermost.

On the other hand, when the key input is made by the down key in S151, the CPU 14 determines whether internal variable x is 10 or not 10 in S158. When the internal variable x is not 10, the CPU 14 adds 1 to the internal x in S159 and determines whether the internal variable x and y satisfy x>y+2 in S160. When x>y+2 is satisfied (Yes in S160), the CPU 14 substitutes the value, which is obtained by subtracting 2 from the internal variable x, for the internal variable y in S161 and ends the focus moving process. When x>y+2 is not satisfied (No in S160), the CPU 14 skips the process of S161 and ends the focus moving process. By the processes of S159, S160, and S161, the focus is moved in the contrastive manner to the processes of S155, S156, and S157.

When the internal variable x is 10 in S158, the CPU 14 substitutes 1 for the internal variable x in S162, substitutes 1 for the internal variable y in S163, and ends the focus moving process. By the processes of S162 and S163, the focus is moved in the contrastive manner to the processes of S153 and S154.

As described above, when the key input in S13 of FIG. 3 is made by the up or down key, the CPU 14 performs the focus moving process. The CPU 14 can move the focus up and down by performing the focus moving process shown in FIG. 4 with the pressing of the up and down keys in the course of displaying the list screen.

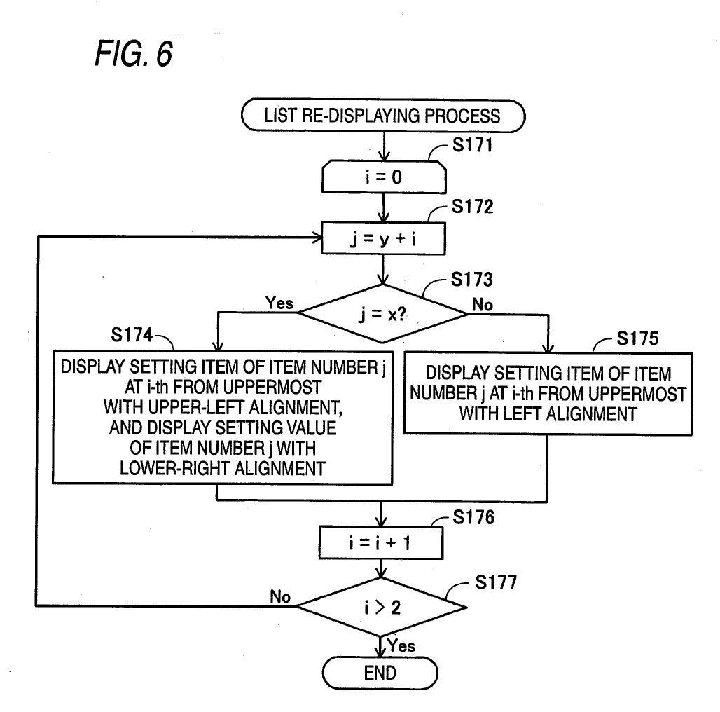

The list re-displaying process of S17 in FIG. 3 will be described with reference to FIG. 6. In S171, the CPU 14 substitutes 0 for a first counter i stored in the basic function work area 32 of the RAM 30 and performs the subsequent loop process. In S172, the CPU 14 substitutes the value, which is obtained by adding the value of the internal variable y and the value of the first counter i, for a second counter j stored in the basic function work area 32 of the RAM 30. In S173, the CPU 14 compares the value of the internal variable x with the value of the second counter j and determines whether j=x is satisfied. When j=x is satisfied (Yes in S173), the CPU 14 reads the value of the first counter i and the value of the second counter j from the basic function work area 32 of the RAM 30 in S174. Then, the CPU 14 displays the setting item of item number j at the i-th position from the uppermost in the list screen including three setting items with the upper-left alignment, and displays the current setting value of the setting item of item number j with the low-right alignment. When j=x is not satisfied (No in S173), the CPU 14 reads the value of the first counter i and the value of the second counter j from the basic function work area 32 of the RAM 30. Then, the CPU 14 displays the setting item of item number j at the i-th position from the uppermost in the list screen including three setting items with the left alignment.

In S176, the CPU 14 adds 1 to the first counter i. In S177, the CPU 14 determines whether the first counter i satisfies a condition i>2. The CPU 14 repeatedly performs the processes subsequent to S172 when the first counter i does not satisfy the condition i>2, and stops the loop and ends the list re-displaying process when the first counter i satisfies the condition i>2.

As described above, the CPU 14 performs the list re-displaying process after performing the focus moving process of S15 in FIG. 3. The CPU 14 re-displays the list screen by performing the list re-displaying process shown in FIG. 6 with the variation of the internal variables x and y in the focus moving process. Accordingly, as shown in FIG. 5, the result of the focus moving process is reflected, in the list screen, and the setting item in the focused state and the setting value of the setting item in the focused state are displayed vertically by two stages. In each of the list screens, three setting items are displayed with the left alignment and the setting value are displayed with the right alignment.

Advantages of this embodiment will be described below. In the multifunction device 10 according to this embodiment, only the setting value of the setting item in the focused state is displayed in the setting item list screen. Accordingly, the setting item in the focused state can be visually distinguished from other setting items and the number of setting items which can be displayed at a time can be guaranteed even when the liquid crystal display 50 is small. For this reason, for example, three setting items as in this embodiment can be displayed. Since a user can refer to the setting value of the setting item in the focused state at the same time when the setting item list screen is displayed, the user who desires to only refer to the current setting value can save operation steps of selecting a setting item and changing a display screen to a setting value selection screen where a current setting value for the setting item is displayed.

In the multifunction device 10 according to this embodiment, since the setting item and the setting value are displayed vertically by two stages in the setting item list screen, it is possible to suppress the enlargement of the display area in the horizontal direction. Accordingly, without the use of icons and the omission of display, the setting item and the setting value can be clearly displayed with character string even when the character string is long.

In the multifunction device 10 according to this embodiment, in the setting item list screen, three setting items are displayed with the left alignment and the setting value of the setting item in the focused state is displayed with the right alignment. This layout for the setting items and the setting value in the setting item list eases a user to visually recognize the setting items and the setting value. Accordingly, it is possible to improve the user's convenience. In the multifunction device 10 according to this embodiment, it is possible to improve the visibility even when the liquid crystal display 50 is small.

Although the embodiment has been described, the embodiment is only an example and does not limit the scope of the claims. The description of the claims encompasses various modifications or changes of the embodiment. Exemplary modifications of the embodiment will be described below.

Although specific examples of the setting items and the setting values in connection with the copy function of the multifunction device 10 have been described, the setting items and the setting values are not limited to these specific examples. For example, the setting items and the setting values may be setting items and setting values in connection with other functions of the multifunction device 10, such as the printer function, the scanner function, the facsimile function, the telephone function, and the network communication function.

Although three setting items are displayed with the left alignment and the setting value is displayed with the right alignment in the list screen, the number of setting items to be displayed and/or the layout of the setting items and the setting value are not limited to those described in connection with the multifunction device 10. For example, two or more setting items may be displayed on the left side (or the right side) of the center of the liquid crystal display 50 and the setting value may be displayed on the right side (or the left side) of the center of the liquid crystal display 50. The setting value of the setting item in the focused state may be displayed at the upper stage and the setting item may be displayed at the lower stage.

In this disclosure, the liquid crystal display 50 is an example of a display unit and the multifunction device 10 is an example of a display device. A focus display unit is embodied by the CPU 14 performing the process of S174 and a non-focus display unit is embodied by the CPU 14 performing the process of S175.

What is claimed is:

1. A display device comprising:
a display unit configured to display a list screen visually listing plural setting items including a first setting item in a focused state and a second setting item in a non-focused state;
a focus display unit configured to allocate two stages for the first setting item, and to display the first setting item in one of the two stages and a current setting value for the first setting item in the other of the two stages in the list screen; and
a non-focus display unit configured to allocate one stage for the second setting item and to display the second setting item in the one stage, without displaying a current setting value for the second setting item, in the list screen.

2. The display device according to claim 1, wherein the two stages includes an upper stage and a lower stage, and the focus display unit is configured to display the first setting item in the upper stage and the current setting value for the first setting item in the lower stage.

3. The display device according to claim 1, wherein the focus display unit is configured to display the first setting item in the one of the two stage with being aligned in a first lateral end of the list screen and the current setting value for the first setting item in the other of the two stages with being aligned in a second, opposite lateral end of the list screen, and
wherein the non-focus display unit is configured to display the second setting item in the one stage with being aligned in the first lateral end.

4. The display device according to claim 3, wherein the first lateral end is a left end, and the second lateral end is a right end.

5. A display device that can perform a predetermined function based on setting values set for plural setting items, that can display, on a display unit, a list screen visually listing at least first and second setting items of the plural setting items, that can specify and set the first setting item into a focused state in the list screen, and that can select the first setting item into a selected state in which a setting value for the first setting item can be input in response to a predetermined input operation, the display device comprising:
a focus display unit configured to allocate two stages for the first setting item, and to display the first setting item in one of the two stages and a current setting value for the first setting item in the other of the two stages in the list screen; and
a non-focus display unit configured to allocate one stage for the second setting item and to display the second setting item in the one stage in the list screen.

6. A display method comprising the steps of:
obtaining, from a memory, first information indicative of a first setting item;
obtaining, from the memory, second information indicative of a second setting item;
obtaining, from the memory, third information indicative of a current setting value for the first setting item;
allocating two stages for the first setting item in a list screen;
allocating one stage for the second setting item in the list screen; and
displaying, on a display unit, the list screen visually displaying the first setting item in one of the two stages, the current setting value in the other of the two stages and the second setting item in the one stage, based on the obtained first, second and third information.

7. A medium storing therein a software program readable and executable by a CPU to perform a function comprising the steps of:
obtaining, from a memory, first information indicative of a first setting item;
obtaining, from the memory, second information indicative of a second setting item;
obtaining, from the memory, third information indicative of a current setting value for the first setting item;
allocating two stages for the first setting item in a list screen;
allocating one stage for the second setting item in the list screen; and
displaying, on a display unit, the list screen visually displaying the first setting item in one of the two stages, the current setting value in the other of the two stages and the second setting item in the one stage, based on the obtained first, second and third information.
